(19) United States
(12) Patent Application Publication
(10) Pub. No.: US 2012/0292914 A1
(43) Pub. Date: Nov. 22, 2012

(54) AIR BLEEDING ARRANGEMENT

(76) Inventor: Niels Allan Pedersen, Bramming (DK)

(21) Appl. No.: 13/471,800

(22) Filed: May 15, 2012

(30) Foreign Application Priority Data
May 16, 2011 (EP) EP11166240

(51) Int. Cl. F28F 27/00; F03D 9/00

(52) U.S. Cl. 290/55; 165/96

(57) ABSTRACT

An air bleeding arrangement for the cooling system includes a cooling system, which contains a locally highest point where air, being present in the cooling system, collects. A bleeding nipple is connected with the locally highest point for the venting of the air collected. The bleeding nipple is connected with the locally highest point via an air bleeding duct. The arrangement provides that the air bleeding nipple is arranged remote from the locally highest point.

### CROSS REFERENCE TO RELATED APPLICATIONS

This application claims priority of European Patent Office application No. 11166240.9 EP filed May 16, 2011. All of the applications are incorporated by reference herein in their entirety.

### FIELD OF INVENTION

The invention relates to an arrangement for bleeding air from a radiator of a cooling system.

### BACKGROUND OF INVENTION

Industrial machinery like motors or generators produces heat and has to be cooled. It is known to install a cooling system using a cooling medium for this purpose. The cooling medium is used to transport heat from the heat-source, e.g. the machinery, to a heat sink, e.g. a radiator. In the radiator the cooling medium is cooled by another medium like surrounding air passing through the radiator.

The cooling medium flows in a cooling circulation comprising pipes. Often air collects over time in the pipes, especially in the uppermost parts of the cooling system. In many cases the radiator is the highest part of the cooling system and air collects in the radiator.

### SUMMARY OF INVENTION

Air is unwanted in the cooling system as it does not contribute to the cooling process. Furthermore the air occupies space in the radiator that is then not available for the cooling medium and the cooling process.

For this the air has to be removed from the cooling system. To remove the air the cooling system comprises a bleeding nipple to allow the air to exit the cooling system.

FIG. 5 shows a radiator 2 in a prior art arrangement for bleeding air 7 that collects in the upper part of the radiator pipes 3.

The radiator 2 is part of a wind turbine cooling system and is connected to the nacelle 9 in free air 10.

The radiator 2 comprises an input pipe 4 that guides the cooling medium 8 into the cooling pipes 3.

An output pipe 5 is connected to the cooling pipes 3 to allow the cooling medium 8 to flow out of the radiator 2. The arrows 11 show the flow of the cooling medium 8.

Over time air 7 collects in the upper part of the radiator 2. To remove the air 7 from the radiator 2 the upper part or the radiator is equipped with a bleeding nipple 6.

A worker has to open one or more of the bleeding nipples to remove the air from the system. This is done during the maintenance of the system. Often the bleeding nipple has to be opened repeatedly during the service to remove as much air as possible from the cooling system.

Especially in cases, where the radiator is placed in higher spots, like on roofs or on a wind turbine nacelle, this service involves a higher safety risk for the worker.

The worker has to leave the nacelle of the wind turbine and work outside the nacelle. Special safety gear is needed for this service.

Sometimes the worker needs tools to operate a bleeding nipple. Thus there is the additional risk that tools might be dropped. In the case of a radiator on a wind turbine nacelle, these tools can fall to the ground and hurt people present close by the wind turbine.

FIG. 6 shows a radiator 2 of a cooling system of a wind turbine. This radiator 2 is normally placed outside the nacelle, mostly on top of the nacelle

The radiator 2 is connected to the nacelle by some supporting frame 1. The radiator 2 is arranged in a way that surrounding air 10 can pass through the radiator 2 to remove the heat from the radiator 2.

The aim of the invention is therefore to provide an arrangement that allows an easier and safer access to the bleeding nipple to remove air out of a cooling system.

This aim is reached by the features of the independent claim(s). Preferred configurations of the invention are object of the dependent claims.

According to the invention the air bleeding arrangement for the cooling system comprises a cooling system, which contains a locally highest point, where air, being present in the cooling system, collects.

A bleeding nipple is connected with the locally highest point for the venting of the air collected. The bleeding nipple is connected with the locally highest point via an air bleeding duct, thus the air bleeding nipple is arranged remote from the locally highest point.

Thus the bleeding nipple can be arranged in another location then the locally highest point, especially in a location that can be easily reached. Thus service personal can easily reach the bleeding nipple without working in potentially dangerous environment such as on roofs.

Most preferably all bleeding nipples of the system can be installed close to each other at a specific location. Thus time is saved as the service personal doesn't have to change their position while the maintenance-work.

Preferably the cooling system comprises ducts, while the locally highest point is part of one of the ducts. Thus the bleeding nipple is connected via an air bleeding duct to the duct of the cooling system.

Preferably the cooling system is arranged to transport heat from a heat source to a heat sink using a cooling medium, which is circulating in ducts. Thus a cooling medium has a high heat capacity and therefore provides an efficient way of cooling.

Preferably the cooling system is part of a wind turbine. Thus the cooling system is transporting heat from different parts of the wind turbine, e.g. the generator or the nacelle, to a heat sink.

Preferably the locally highest point is located outside the nacelle of the wind turbine. Thus the cooling medium easily flows from the heat source in the wind turbine to the heat sink outside the nacelle.

Preferably a radiator, which is mounted on top of the nacelle, comprises the locally highest point of the cooling system. Thus the cooling medium can be cooled very effectively in a radiator. The radiator is mounted in the surrounding air on top of the nacelle of the wind turbine. Thus the wind is moving through the radiator for cooling purposes.

Preferably the air bleeding duct is arranged at an outer side of the input pipe or the output pipe of the radiator. Thus the free space for the air to move through the radiator is not restricted by the bleeding duct.

In another preferred embodiment the radiator comprises at least two layers of cooling pipes. The air bleeding duct is arranged at least partially between two layers of cooling pipes. Thus the air bleeding duct is protected during installation of the radiator on top of the nacelle of the wind turbine.

Preferably the air bleeding duct is at least partially arranged within a duct, being used for the circulation of cooling medium within the radiator. Thus the bleeding duct is an integrated part of the radiator that is protected and does not block the open space of the radiator for the air moving through the radiator.

Preferably the bleeding nipple is arranged at a position, which is chosen in a way that operation of the nipple or maintenance of the cooling system by service personal is allowed. Thus the service personal can reach the bleeding nipple directly without the help of ladders or tools. Thus the use of bigger tools such as ladders can be prevented and time is saved in the maintenance.

Preferably the position is nearby or close to the nacelle, thus operation of the nipple or maintenance of the cooling system is allowed by service personal from inside the nacelle. Thus the service personal can reach the bleeding nipple through an opening or a hatch without leaving the nacelle. Thus service personal doesn't have to climb on top of the nacelle to operate the bleeding nipple. Thus the risk of accidents is reduced. Furthermore time for the maintenance is saved, as the steps of operating a bleeding nipple often have to be repeated.

Preferably the bleeding nipple is arranged inside the nacelle. Thus the service personal can reach the bleeding nipple without leaving the nacelle and without opening a hatch. Thus service personal can operate the bleeding nipple within the nacelle, so also tools that might be necessary to perform maintenance work can not fall from the nacelle down to the ground. Thus injuries are prevented.

### BRIEF DESCRIPTION OF THE DRAWINGS

The invention is shown in more detail by help of figures. The figures show preferred configurations and do not limit the scope of the invention.

FIG. 1 shows a preferred embodiment of the solution invented,

FIG. 2 shows a horizontal cut through the input pipe or the output pipe of the radiator and the air bleeding duct,

FIG. 3 shows a horizontal cut through another embodiment of the input pipe or the output pipe of the radiator,

FIG. 4 shows another preferred embodiment of the invention with the bleeding duct arranged in another duct,

FIG. 5 shows a prior-art radiator of a wind turbine cooling system as described above in the introduction part,

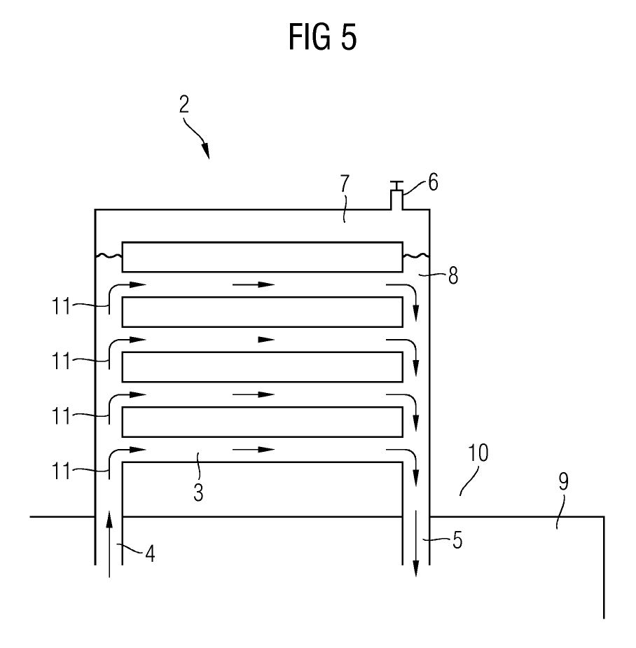

FIG. 6 shows a prior-art radiator arranged in a wind turbine cooling system as described above in the introduction part.

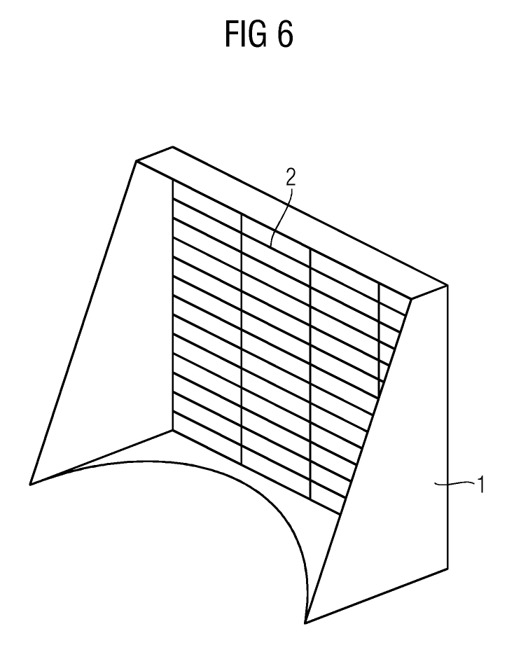

### DETAILED DESCRIPTION OF INVENTION

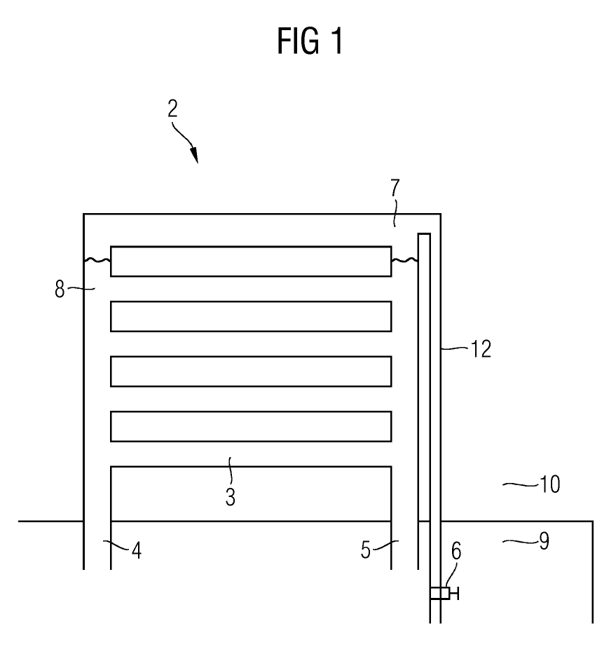

FIG. 1 shows a radiator 2 as used in a cooling system in a wind turbine. An input pipe 4 and an output pipe 5 are connected to the cooling pipes 3 so that the cooling medium 8 can flow from the input pipe 4 through the cooling pipes 3 to the output pipe 5.

Over time air 7 collects in the upper part of the radiator 2. To remove this air 7 an air bleeding duct 12 is connected to the upper part of the radiator that leads into the nacelle 9 of the wind turbine. The air bleeding duct 12 is equipped with a bleeding nipple 6. When the bleeding nipple 6 is opened the air 7 can be removed from the radiator 2.

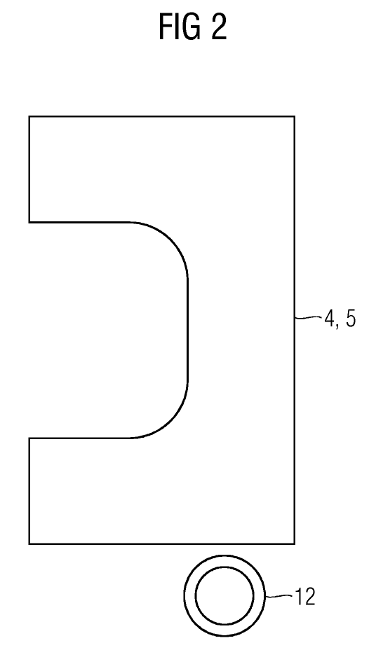

FIG. 2 shows a horizontal cut through the input pipe 4 or the output pipe 5 of the radiator 2 and the air bleeding duct 12. In this embodiment the radiator 2 has two layers of cooling pipes 3, a first layer seen from the direction of the wind passing through the radiator 2. A second layer is arranged behind the first layer seen from the direction of the wind passing through the radiator 2. Between the layers of cooling pipes 3 there is an open space. The input pipe 4 and the output pipe 5 connect the pipes 3 of both layers of cooling pipes 3. In the horizontal cut through the input pipe 4 or the output pipe 5 the input pipe 4 or the output pipe 5 show a U-shaped form. The first layer of cooling pipes 3 is connected to a first end of the U and the second layer of cooling pipes 3 to a second end of the U. The air bleeding duct 12 is arranged at the outer side of the U-shaped form of the input pipe 4 or the output pipe 5.

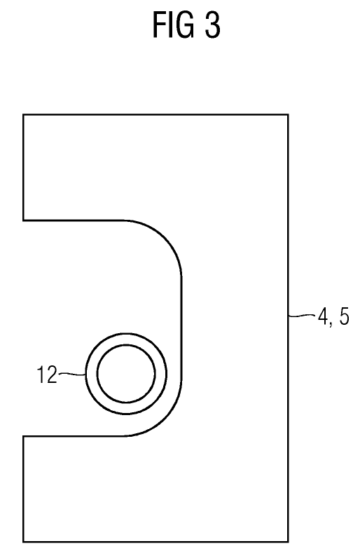

FIG. 3 shows a horizontal cut through another embodiment of the input pipe 4 or the output pipe 5 of the radiator 2. The figure shows the input pipe 4 or the output pipe 5 as described in the description of FIG. 2. The air bleeding duct 12 is arranged at the inner side of the U-shaped form of the input pipe 4 or the output pipe 5.

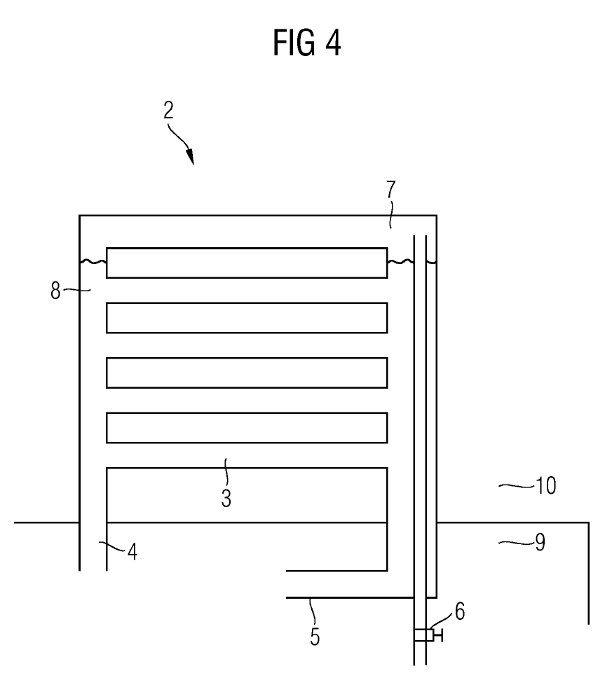

FIG. 4 shows another embodiment of the invention. It shows the radiator 2 with the cooling pipes 3, the input pipe 4 and the output pipe 5. The radiator 2 is mounted to the nacelle 9 in the surrounding free air 10. In this embodiment the air bleeding duct 12 is guided partially inside the output pipe 5. The air bleeding duct 12 comprises a bleeding nipple 6 which can be operated from inside the nacelle 9.

1. An air bleeding arrangement for a cooling system, comprising
a cooling system having a locally highest point, where air that is present in the cooling system collects,
a bleeding nipple, which is connected with the locally highest point for the venting of the air collected,
wherein the bleeding nipple is connected with the locally highest point via an air bleeding duct, such that the bleeding nipple is arranged remote from the locally highest point.

2. The air bleeding arrangement according to claim 1, wherein the cooling system comprises ducts, while the locally highest point is part of one of the ducts.

3. The air bleeding arrangement according to claim 2, wherein the cooling system is arranged to transport heat from a heat source to a heat sink using a cooling medium, which is circulating in the ducts.

4. The air bleeding arrangement according to claim 3, wherein the cooling system is part of a wind turbine.

5. The air bleeding arrangement according to claim 4, wherein the locally highest point is located outside a nacelle of the wind turbine.

6. The air bleeding arrangement according to claim 5, wherein a radiator is provided, which is mounted on top of the nacelle, the radiator comprising the locally highest point of the cooling system.

7. The air bleeding arrangement according to claim 6, wherein the air bleeding duct is arranged at an outer side of an input pipe or an output pipe of the radiator.

8. The air bleeding arrangement according to claim 6,
wherein the radiator comprises at least two layers of cooling pipes, and
wherein the air bleeding duct is arranged at least partially between two layers of cooling pipes.

9. The air bleeding arrangement according to claim 6, wherein the air bleeding duct is at least partially arranged within a duct, being used for the circulation of cooling medium within the radiator.

10. The air bleeding arrangement according to claim 4, wherein the bleeding nipple is arranged at a position, which is chosen in a way that operation of the nipple or maintenance of the cooling system by service personnel is allowed.

11. The air bleeding arrangement according to claim 4, wherein the position of the bleeding nipple is proximate to the nacelle, wherein an operation of the nipple or maintenance of the cooling system is allowed by service personnel from the nacelle-inside.

12. The air bleeding arrangement according to claim 4, wherein the bleeding nipple is arranged inside the nacelle.
